(19) United States
(12) Patent Application Publication
(10) Pub. No.: US 2025/0164278 A1
(43) Pub. Date: May 22, 2025

(54) METHOD AND DEVICE FOR PROVIDING AN ADAPTIVE MAP FOR DIVERSE AUTONOMOUS NAVIGATION PLATFORMS

(71) Applicant: KAKAO MOBILITY CORP., Gyeonggi-do (KR)

(72) Inventors: Seung Hwan HONG, Gyeonggi-do (KR); Yun Yeong CHOI, Gyeonggi-do (KR)

(73) Assignee: KAKAO MOBILITY CORP., Gyeonggi-do (KR)

(21) Appl. No.: 18/522,846

(22) Filed: Nov. 29, 2023

(30) Foreign Application Priority Data
Nov. 20, 2023 (KR) 10-2023-0160442

(51) Int. Cl. G01C 21/00; G06V 20/58

(52) U.S. Cl. CPC G01C 21/3859; G01C 21/3815; G01C 21/3837; G06V 20/58

(57) ABSTRACT

Disclosed herein a method and device for providing an adaptive map for diverse autonomous navigation platforms. The method includes: generating environment information around a moving object based on perception information acquired from the moving object equipped with a sensor; selecting at least one piece of map information among multiple pieces of map information based on characteristics information of a type of the moving object, the moving object, which includes at least one of sensing performance of the moving object, processing performance of the moving object, and communication performance of the moving object, and the environment information; adjusting the map information based on situation information representing a situation around the moving object recognized from the environment information; and transmitting the adjusted map information to the moving object.

### CROSS REFERENCE TO RELATED APPLICATION

The present application claims priority to a Korean patent application 10-2023-0160442, filed Nov. 20, 2023, the entire contents of which are incorporated herein for all purposes by this reference.

### BACKGROUND OF THE INVENTION

### Field of the Invention

The present disclosure relates to a method and device for providing an adaptive map for diverse autonomous navigation platforms, and more particularly, to a method and device for providing an adaptive map, which dynamically apply map information in real time in order to implement a map service in diverse autonomous navigation devices having unique operation methods.

### Description of the Related Art

Autonomous moving objects are being developed in various mobility areas such as vehicles, robots, unmanned mobility devices, and drones, and commercialization thereof is sought.

As autonomous driving is being applied more broadly than ever, the demand for accurate and flexible map information is on the rise. Many difficulties occur in individually providing or generating map information suitable for various devices covering unmanned drones to autonomous driving cars, and such diversity may cause inefficiency and fragmented operations.

In addition, an autonomous moving object may establish a driving plan and perform a determining process by referring to a preset path of a map, and the autonomous moving object may predict expected paths of neighboring objects by referring to movement paths of the neighboring objects. However, in case actual movement paths and preset movement paths of a moving object and a neighboring object are different, the moving object may cause a malfunction or an accident.

Because a high definition (HD) map for autonomous driving has high accuracy and a large amount of information, a lot of resources are consumed to construct and update the HD map. Accordingly, various autonomous navigation devices have limitations with providing suitable data for operating conditions, that is, for requirements for responding to various types of environments on a path. Especially, the real-time update and adaptation of information slows down according to an environment or a state change of a moving object, and this may hinder a device from efficiently operating.

Besides, when increasing an amount of data used for a map in order to prevent fragmentation, the processing speed or communication efficiency may become problematic. On the other hand, when decreasing an amount of data, the accuracy of an autonomous navigation may be lowered.

In addition, an integrated service may be difficult to provide because of different map data formats and communication protocols according to autonomous driving and navigation systems.

### SUMMARY

The present disclosure is technically directed to providing a method and device for providing an adaptive map for diverse autonomous navigation platforms that dynamically apply map information in real time in order to implement a map service in diverse autonomous navigation devices having unique operation methods.

In addition, the present disclosure is also technically directed to providing a method and device for providing an adaptive map which support autonomous driving achieving greater flexibility and safety in diverse situations on a path by using real-time data and an AI-based algorithm to select and adjust a proper map for a surrounding environment and conditions.

The technical objects of the present disclosure are not limited to the above-mentioned technical objects, and other technical objects that are not mentioned will be clearly understood by those skilled in the art through the following descriptions.

According to the present disclosure, there is provided a method for providing an adaptive map for diverse autonomous navigation platforms, the method comprising: generating environment information around a moving object based on perception information acquired from the moving object equipped with a sensor; selecting at least one piece of map information among multiple pieces of map information based on characteristics information of a type of the moving object, the moving object, which includes at least one of sensing performance of the moving object, processing performance of the moving object, and communication performance of the moving object, and the environment information; adjusting the map information based on situation information representing a situation around the moving object recognized from the environment information; and transmitting the adjusted map information to the moving object.

According to the embodiment of the present disclosure in the method, the plurality of map information may include a base map made in a format according to a predetermined regulation, a geometric map geometrically expressing an object element on a road in which the moving object is drivable, an occupancy map that expresses an object element having a dynamic behavior on the road in a grid form, a semantic map including at least connection relation information that defines object elements connected on the road, a prior knowledge map including at least operating information of an object element that controls driving of the moving object on the road, a real-time knowledge map including at least association information that defines data mutually associated in the situation information, and a map for positioning for supporting positioning of the moving map.

According to the embodiment of the present disclosure in the method, the perception information may include direct recognition information and indirect recognition information that the moving object acquires, the direct recognition information may be recognition information that the moving object detects on its own, and the indirect recognition information may be recognition information, which detects an object element beyond a perception range of a sensor of the moving object, and is recognition obtained from another moving object near the moving object.

According to the embodiment of the present disclosure in the method, the environment information may be generated based on perception information of an object element transmitted from the moving object and another moving object near the moving object, and the perception information may be collected as multiple pieces of perception information in order to have multiple views in time series.

According to the embodiment of the present disclosure in the method, the type of the moving object may include at least one of a ground moving object, an aerial moving object, and a marine moving object, the map information is selected based on at least requirement-specialized information determined according to the type of the moving object, and the requirement-specialized information may include information required for the map information based on at least one of a moving object flow pattern, path safety degree, and function maintenance degree of a specific module of the moving object.

According to the embodiment of the present disclosure in the method, the map information may be constructed to include path information of the moving object, and the map information may be determined based on additional data together with the characteristics information of the moving object and the environment information of the moving object. Also, the additional data may include at least one of movement pattern information of the moving object, which is identified by history information of the moving object, similarity information on a path similar to a movement course or a traffic state of the movement course, a use frequency of the path information in the course, a modification frequency of the path information, a request frequency of a user for the path information, and map evaluation information generated by a simulation using a potential traffic state inferred from the environment information.

According to the embodiment of the present disclosure in the method, the adjusting of the map information may include generating second map information corresponding to a presence region of the situation information by referring to first map information selected according to the environment information in front of the presence region and the environment information of the presence region, in response to the moving object being predicted to enter the presence region. Also, the first map information and the second map information may be configured as different types of information.

According to the embodiment of the present disclosure in the method, the adjusting of the map information may include providing path information to the map information based on at least one of path information already generated by past data associated with the situation information and path information derived from a prediction model according to training based on the situation information.

According to the embodiment of the present disclosure in the method, the method may further comprise: adjusting the map information in detail based on user information and mobility details information, prior to the transmitting of the adjusted map information to the moving object. The user information may include at least one of a preferred path in a course, where the moving object moves, and a path pattern, and the mobility details information includes sensor information including a detailed specification of the sensor and detailed performance of the sensor and mobility constraint information according to the type and a specification of the moving object.

According to the embodiment of the present disclosure in the method, the method may further comprise: acquiring feedback information associated with use of the map information obtained during control of a movement of the moving object according to the adjusted map information; and updating the map information based on the feedback information. The updating may include updating the map information based on result data verified by a simulation using movement data of the moving object derived from the feedback information.

According to another embodiment of the present disclosure, there is provided a device for providing an adaptive map for diverse autonomous navigation platforms, the device comprising: a communication unit configured to exchange data with a moving object; a memory configured to store at least one instruction; and a processor configured to execute the at least one instruction by using the data. The processor is further configured to: generate environment information around a moving object based on perception information acquired from the moving object equipped with a sensor, select at least one piece of map information among multiple pieces of map information based on characteristics information of the moving object, which includes at least one of a type of the moving object, sensing performance of the moving object, processing performance of the moving object, and communication performance of the moving object, and the environment information, adjust the map information based on situation information representing a situation around the moving object recognized from the environment information, and transmit the adjusted map information to the moving object.

The features briefly summarized above for this disclosure are only exemplary aspects of the detailed description of the disclosure which follow, and are not intended to limit the scope of the disclosure.

According to the present disclosure, it is possible to provide a method and device for providing an adaptive map for diverse autonomous navigation platforms that dynamically apply map information in real time in order to implement a map service in diverse autonomous navigation devices having unique operation methods.

In addition, according to the present disclosure, by reflecting an environment of an actual path in map information, the accuracy and safety of perception, planning and decision processes of an autonomous moving object can be improved, and the accuracy and productivity of map information for autonomous driving can be increased.

According to the present disclosure, as map information is optimized through real-time path analysis, continuous provision of dynamic information on a road structure and a road, perception of a connection relation between objects on a movement path, and map update, the predictability can be ensured for a behavior of a moving object, the accuracy of a navigation system can be improved, and traffic flow can be optimized.

The effects obtainable from the present disclosure are not limited to the above-mentioned effects, and other effects not mentioned herein will be clearly understood by those skilled in the art through the following descriptions.

### BRIEF DESCRIPTION OF THE DRAWINGS

FIG. 1 is a view exemplifying a moving object communicating with a server and another device to transmit and receive data.

FIG. 2 is a block diagram of a moving object exemplified in the present disclosure.

FIG. 3 is a block diagram of a server according to one embodiment of the present disclosure.

FIG. 4 is a flowchart of a method for providing an adaptive map according to another embodiment of the present disclosure.

FIG. 5 is a view exemplifying positioning and observational connectivity of a plurality of moving objects.

FIG. 6 is a view exemplifying generation processing of environment information.

FIG. 7 is a view exemplifying real-time adjustment of map information.

### DETAILED DESCRIPTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

In the present disclosure, each of phrases such as “A or B”, “at least one of A and B”, “at least one of A or B”, “A, B or C”, “at least one of A, B and C”, “at Each of the phrases such as “at least one of A, B or C” and “at least one of A, B, C or combination thereof” may include any one or all possible combinations of the items listed together in the corresponding one of the phrases.

Hereinafter, embodiments of the present disclosure will be described with reference to the accompanying drawings.

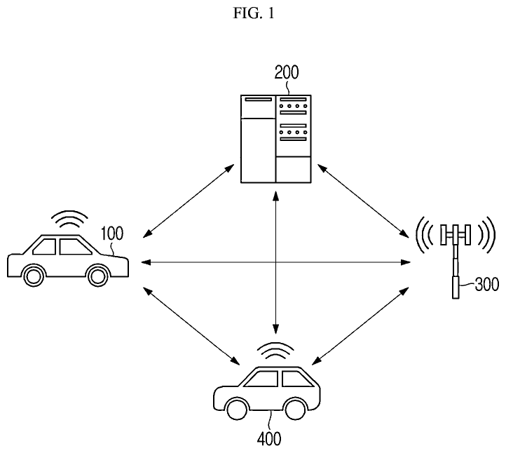

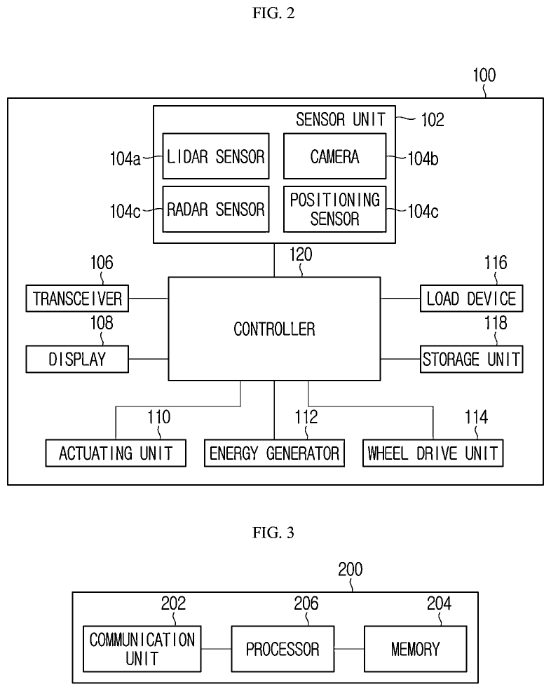

Hereinafter, referring to FIGS. 1 to 3, a method and device for providing an adaptive map for diverse autonomous navigation platforms will be described. FIG. 1 is a view exemplifying a moving object communicating with a server and another device to transmit and receive data. FIG. 2 is a block diagram of a moving object exemplified in the present disclosure. FIG. 3 is a block diagram of a server according to one embodiment of the present disclosure.

Referring to FIG. 1, a moving object 100 may be a mobility device moving on the ground, in the air, or at sea and used for a specific purpose. For example, the moving object 100 may be a device, a robot, a drone, or a ship. As an example, the moving object 100 may be a mobility device implementing autonomous movement in communication with a server 200 and other devices 300 and 400. The moving object 100 may transmit various types of information obtained during driving, for example, perception information based on multiple sensors, positioning information, and environment information associated with a movement path to the server 200, and based on the above-described information, the server 200 may transmit path information, map information, driving assistance information, and software to the moving object 100. As another example, the moving object 100 may exchange the above-described information in communication with the server 200 and the other devices 300 and 400 and obtain navigation information that guides a movement path. In the present disclosure, the server 200 may be operated as an autonomous driving assistant device that constructs path information of autonomous driving based on a behavior of the moving object 100, perception information of an object element collected from the moving object 100, and positioning information. In addition to having path information and navigation information, the server 200 may also function as a device for providing an adaptive map, which provides map information appropriate for a surrounding environment of the moving object 100, characteristics information of the moving object 100, and information associated with a user of the moving object 100.

The present disclosure mainly describes an example of the moving object 100 as a vehicle but may also be applied to another type of moving objects described above. Hereinafter, for convenience of explanation, the moving object 100 and a vehicle may be described interchangeably.

In case the moving object 100 is a vehicle, the moving object 100 may be driven based on electric energy or fossil energy. In the case of electric energy, for example, the moving object 100 may be a pure battery-based vehicle driven only by a high-voltage battery or employ a gas-based fuel cell as an energy source. In addition, a fuel cell may use various types of gas capable of generating electric energy, and for example, the gas may be hydrogen. However, without being limited thereto, various gases may be applicable. In the case of fossil energy, the moving object 100 is driven based on fuels such as gasoline, diesel, or liquefied gas, and may be equipped with an engine that drives a wheel drive unit 114 by combustion of the fuel. The engine may be included in an energy generator 112 from a perspective of providing a driving torque of a wheel to the wheel drive unit 114.

The moving object 100 may be driven by being controlled in autonomous driving, and the autonomous driving may be implemented as semi-autonomous driving or full autonomous driving. Full autonomous driving may be provided as autonomous moving under the complete control of a controller 120 of the moving object 100 without a user's intervention even in an uncertain driving situation. Semi-autonomous driving may be provided as autonomous moving that requires a driver's intervention in a specific driving situation. When the driving situation occurs, semi-autonomous driving may be implemented such that the controller 120 disables autonomous driving and switches control to the user, and thus the user performs manual driving.

Meanwhile, the moving object 100 may perform communication with other devices 200 and 300 or another moving object 400. For example, another device may include a server 200 for supporting various control, state management and driving of the moving object 100, an ITS device 300 for receiving information from an intelligent transportation system (ITS), and various types of user devices. In order to support autonomous driving and various services for the moving object 100, the server 200 may transmit various types of information and software modules used for controlling the moving object 100 to the moving object 100 as a response to a request and data transmitted from the moving object 100 and a user device.

For example, the ITS device 300 may be a road side unit (RSU), and the ITS device 300 may assist a user in driving his own car or support autonomous driving of the moving object 100 by exchanging vehicle recognition data, driving control and situation data, environment data surrounding a vehicle, and map data through V2I with the moving object 100. Through V2V with the another moving object 400, the moving object 100 may support a driver's driving his own car or autonomous driving by exchanging the above-listed data.

The moving object 100 may communicate with another vehicle or another device based on cellular communication, wireless access in vehicular environment (WAVE) communication, dedicated short range communication (DSRC) or short range communication, or any other communication scheme.

For example, the moving object 100 may use LTE as a cellular communication network, a communication network such as 5G, a WiFi communication network, a WAVE communication network, and the like to communicate with the server 200, the ITS device 300, and the another moving object 400. As another example, DSRC used in the moving object 100 may be used for vehicle-to-vehicle communication. A communication scheme among the moving object 100, the server 200, the ITS device 300, the another moving object 400, and a user device is not limited to the above-described embodiment.

Referring to FIG. 2, the moving object 100 may include a sensor unit 102, a transceiver 106, and a display 108.

The sensor unit 102 may be equipped with various types of detectors for sensing various states and situations occurring external and internal environments and for identifying positioning information of the moving object 100. That is, the sensor unit 102 may be configured as a multiple sensor module including heterogeneous sensors to obtain sensing data detected from each of the sensors.

Specifically, the sensor unit 102 may be equipped with an observation sensor for perceiving dynamic and static objects present around the moving object 100 and have a positioning sensor 104d capable of obtaining location information and orientation information of a vehicle. The observation sensor may be configured as a multiple sensor having a Lidar sensor 104a, a camera serving as an image sensor 104b, and a radar sensor 104c. The sensor unit 102 may obtain sensor data including perception information and positioning information by the above-described sensors. Perception information may include Lidar data including 3D perception data of neighboring objects obtained by the Lidar sensor 104a, 2D image data of neighboring objects obtained by the camera 104b, and radar data detecting the presence and movement states of neighboring objects.

The Lidar sensor 104a may be a type of 3D perception sensor according to the present disclosure. The Lidar sensor 104a may be a sensor that observes a surrounding environment based on laser scanning and perceives a three-dimensional shape of an object. Specifically, the Lidar sensor 104a may obtain three-dimensional perception data for a surrounding environment and an object by scanning laser around the moving object 100. Three-dimensional perception data may include a point cloud representing a three-dimensional shape of an object, that is, detection data and image data for observation representing a surrounding environment. For example, since detection data represent three-dimensional contours and shapes of objects and an arrangement of objects, the detection data may be provided to identify each object. For example, image data may be provided to identify an object and a surrounding environment through images of the object and the surrounding environment.

The camera 104b may obtain two-dimensional image data or image data with depth information for a surrounding environment of the moving object 100 and an object. For example, the radar sensor 104c may irradiate an electromagnetic wave with a predetermined wavelength and thus detect a behavior of an object based on an electromagnetic wave reflected from the object. For example, the behavior of an object may include the presence of the object, whether the object moves, a distance between the moving object 100 and the object, a speed of the object, and a movement direction.

To identify positioning information including its own location, a driving position, a speed, and the like, the positioning sensor 104d may be composed of a global navigation satellite system (GNSS), an inertial measurement unit (IMU), an inertial navigation system (INS), a wheel encoder, a steering sensor, and the like.

The present disclosure mainly describes sensors of the sensor units referred to for description of an embodiment but may further a sensor for detecting various situations not listed herein.

The transceiver 106 may support mutual communication with the server 200, the ITS device 300, and the neighboring moving object 400. In the present disclosure, the transceiver 106 may transmit data generated or stored during driving to the server 200 and receive data and a software module transmitted from the server 200. In the present disclosure, the moving object 100 may transmit and receive data used in a method according to the present disclosure to and from the outside through the transceiver 106.

The display 108 may serve as a user interface. By the controller 120, the display 108 may display an operating state and a control state of the moving object 100, route/traffic information, information on an energy remaining quantity, a content requested by a driver, and the like to be output. The display 108 may display path information, map information, and various types of information associated with a driving path transmitted from the server 200. The display 108 may be configured as a touch screen capable of sensing a driver input and receive a request of a driver indicated to the controller 120.

Meanwhile, the moving object 100 may include an actuating unit 110, the energy generator 112, the wheel drive unit 114, and a load device 116.

The actuating unit 110 may be equipped with at least one module for implementing a driving operation and perform at least one driving operation of longitudinal control like acceleration/deceleration and transverse control like steering. The actuating unit 110 may be equipped with not only a pedal and a steering wheel accepting a user's request for the control but also various operating modules for generating a driving operation according to the request in the wheel drive unit 114.

The energy generator 112 may generate and supply power and electricity used for a driving power system like the wheel drive unit 114 and the load device 116. In case the moving object 110 is driven based on electric energy, for example, the energy generator 112 may be configured as an electric battery or be configured as a combination of an electric battery and a fuel cell for charging the battery. In case the moving object 100 is driven based on fossil energy, the energy generator 112 may be configured as an internal combustion engine.

The wheel drive unit 114 may include a plurality of wheels, a driving force transfer module for generating and giving a driving force to wheels or for transferring a driving force, a braking module for decelerating the driving of wheels, and a steering module for realizing transverse control of wheels. In case the moving object 100 is driven based on electric energy, the driving force transfer module may be configured as a motor module that generates a driving force based on power output from an electric battery. In case the moving object 100 is operated based on fossil energy, a driving force transfer module may be equipped with transmission and a gear module that transfer power of an internal combustion engine.

The load device 116 may be an auxiliary equipment mounted on the moving object 100, which consumes power supplied from the energy generator 112 by use of an occupant or user or converted from output of the energy generator 112. The load device may be a type of electric device for non-driving purpose excluding a driving power system like the wheel drive unit 114 in the present disclosure. For example, the load device 114 may be various devices installed in an air-conditioning system, a light system, a seat system and the moving object 100.

In addition, the moving object 100 may include a storage 118 and the controller 120.

The storage unit 118 may store an application for controlling the moving object 100 and various data and load the application or read and record data at a request of the controller 120.

In the present disclosure, the storage unit 118 may store an application for generating real-time environment information based on perception information and positioning information obtained from the sensor unit 102 of the moving object 100 and external information received from an external device. Perception information and positioning information may be generated by recognizing a behavior of the moving object 100 and an object element near the moving object 100. Perception information may include direct recognition information and indirect recognition information that the moving object 100 obtains. Direct recognition information may be recognition information that the moving object 100 detects on its own. Indirect recognition information is recognition information that detects an object element exceeding a perception range of the observation sensors 104a to 104c of the moving object 100, and it may be recognition information obtained from another moving object near the moving object. For example, an external device may be the server 200, the ITS device 300 and/or the neighboring moving object 400.

An object element may include a road object and an external object. The road object may include a region where the moving object 100 is moved, for example, a static road object and a dynamic road object present on a road. For example, the static road object may be sign information for traffic control, a facility on a road, and the like. The dynamic road object may be an object with mobility that moves on a lane near a driving lane of the moving object 100. For example, the dynamic road object may be a vehicle moving on a nearby lane in a same or opposite direction, a vehicle driven on each lane connected to an intersection, a pedestrian/mobility crossing a crosswalk, and the like. A vehicle is described an example of the dynamic road object, but without being limited thereto, various types of ground mobilities moving on a road or a detailed lane of the road may correspond to dynamic road objects.

The external object may include a static object like a building and a sidewalk installed outside a road and a dynamic object like a pedestrian and a bicycle moving near a road.

The environment information may be information associated with an object element near a moving object inferred from perception information and positioning information. The information associated with an object element may include the type, location, shape and movement trajectory of an object identified as an object element. The information associated with an object element may include a traffic flow state inferred from a behavior of a dynamic road object, an operation state of a road traffic facility recognized from the observation sensors 104a to 104c, and an event recognized from the observation sensors 104a to 104c.

In addition, the environment information may include external information received from an external device, for example, situation information and operation information of a traffic control facility. The situation information is information on an event occurring on a path of the moving object 100, for example, a traffic flow state, accident information, work information, and weather information. For example, the operation information may include duration, standby time, and the like which are associated with stop, driving and caution of a traffic light installed on a road. That is, the environment information is information on an element that is inferred to affect movement control of the moving object 100, and may be generated by at least one of a state of a static road object, a state including a movement trajectory of a dynamic road object, situation information, and operation information.

Meanwhile, the storage unit 118 may store and manage map information including path information and various information associated with a driving path from the server 200. Map information may be used to generate a driving path set to the moving object 100 at a request of a user or the controller 120. In addition, map information may be used for autonomous driving and include a low definition map or include an HD map together with the map. Map information may be provided to have various information and data included in the above-described object and environment.

The controller 120 may perform overall control of the moving object 100. The controller 120 may be configured to execute an application and an instruction stored in the storage unit 118. The controller 120 may enable autonomous driving in response to an autonomous driving request by a user or a setting of the moving object 100 itself and control the moving object 100. In addition, the controller 120 may disable autonomous driving by a user's release or at a request according to automatic release and control the moving object 100 to be manually driven.

In the present disclosure, by using an application, an instruction, and data stored in the storage unit 118, the controller 120 may generate real-time environment information based on perception information and positioning information obtained from the sensor unit 102 of the moving object 100 and external information received from an external device. In addition, the controller 120 may receive optimal map information by transmitting environment information, detailed information associated with the moving object 100, and user information associated with a user of the moving object 100. Characteristics information may include at least one of a type of the moving object 100, sensing performance of the moving object 100, processing performance of the moving object 100, and communication performance of the moving object 100. User information may include at least one of a preferred path on a course where the moving object 100 moves, and a path pattern. User information is not limited to what is described above but may include an option associated with driving and a path selected by a user and driving experience and path experience inferred by learning.

In addition, the controller 120 may transmit mobility details information to the server 200. The mobility details information may be information referred when the server 200 adjusts or refines detailed data and a detailed setting of map information. For example, mobility details information may include sensor information, which includes a detailed specification of the sensor unit 102 including the observation sensors 104a to 104c and the positioning sensor 104d and detailed performance of the sensor unit 102, and mobility constraint information according to a type and a specification of the moving object 100. For example, the sensor information may also include a detailed specification of the observation sensors 104a to 104c and the positioning sensor 104d, an observation range of the observation sensors 104a to 104c, a detailed resolution, a calibration method, a type of a sensor constituting the positioning sensor 104d, a fine precision of the positioning sensor 104d, and the like. For example, the mobility constraint information may be profile information including a constraint of a movement environment required based on a type of the moving object 100, that is, ground, flying, and marine moving objects, and a preferred applied element necessary for map information.

In the present disclosure, as an example, the controller 120 may be implemented as a single processing module, or as another example, the above-described processing may be distributed processing over a plurality of processing modules.

Referring to FIG. 3, as described above, the server 200 may serve as an autonomous driving assistant device and include a communication unit 202, a memory 204, and a processor 206.

The communication unit 202 may support mutual communication with the moving object 100, the ITS device 300, and the neighboring moving vehicle 400. In the present disclosure, the communication unit 202 may receive data generated or stored during driving of the moving object 100 and the neighboring moving object 400 and receive data and a software module from the moving object 100 and the neighboring moving object 400. As exemplified in FIG. 1, the communication unit 202 may receive environment information from a plurality of moving objects, that is, the moving object 100 and another moving object 400. In addition, optimal map information, which the processor 206 generates suitably for each moving object 100 based on environment information, may be transmitted to each moving object 100 through the communication unit 202. In addition, real-time situation perception, path update, and an urgent command, which are generated by the processor 206, may be transmitted to the plurality of moving objects 100 through the communication unit 202.

The memory 204 may store an application for controlling the server 200 and various data and load the application or read and record data at a request of the processor 206. In the present disclosure, the memory 204 may store an application for providing optimal map information, based on environment information transmitted from the moving object 100, performance information of the moving object 100, and user information. The optimal map information may include path information of the moving object 100 itself. In addition, as for map information, path information associated with a dynamic road object present near the moving object 100 may be transmitted in order to establish a path applied to autonomous driving of the moving object 100.

Specifically, the memory 204 may store an application and at least one instruction for processing selection, adjustment, transmission, feedback and update of map information.

Meanwhile, in order to transmit optimal map information, the memory 204 may have a map library holding multiple types of map information. For example, the map library may manage each of multiple types of maps or manage individual components constituting a map in a layer form. Individual components may be detailed map data required in a specific type to provide the specific type of map, for example, individual data associated with a state of an object element, a movement trajectory of an object element, situation information, and operation information of a traffic control facility.

The processor 206 may perform overall control of the server 200. The processor 206 may be configured to execute an application and an instruction stored in the memory 204.

In the present disclosure, by using an application, an instruction and data that are stored in the memory 204, the processor 206 may select map information based on characteristics information of the moving object 100, environment information and external information, and adjust the map information based on situation information. The processor 202 may adjust map information in detail based on user information and mobility details information, transmit the adjusted map information to the moving object 100, and update the map information according to feedback information on the map information transmitted from the moving object 100.

In the present disclosure, as an example, the processor 206 may be implemented as a single processing module, or as another example, the above-described processing may be distributed processing over a plurality of processing modules.

In the present disclosure, a plurality of moving objects 100 may generate and transmit real-time environment information, and the server 200 may infer a context on a course where the plurality of moving objects 100 are moving, by using learning based on multiple pieces of environment information, and generate integrated environment information based on the inferred context. The context may be inferred to have a situation element referred to for movement control through a movement trajectory of the plurality of moving objects 100, that is, through trajectorys of the plurality of moving objects 100. The integrated environment information may include predicted environment information expected based on the inferred context, apart from the real-time environment information. As another example, a part of the plurality of moving objects 100 may transmit perception information, observation information, and recognized situation information to the server 200, and the server 200 may generate integrated environment information based on the above-described pieces of information.

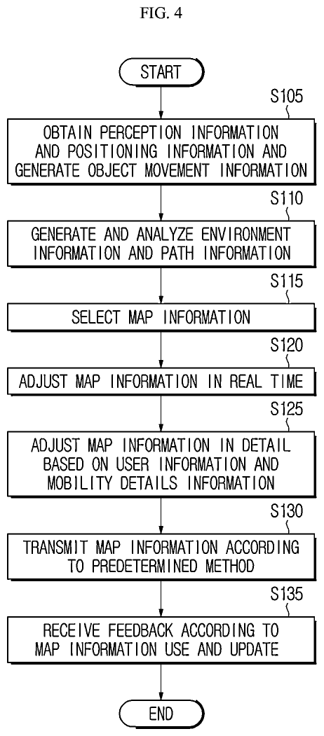

Hereinafter, for convenience of explanation, will be described an embodiment in which the plurality of moving objects 100 generate real-time environment information and transmit the real-time environment information to the server 200. Specifically, the processing of the controller 120 of the above-described moving object and the processor 206 of the server 200 will be described in detail through FIGS. 4 to 7. However, the embodiment below may be applied to another example in which real-time environment information is generated in the server 200.

FIG. 4 is a flowchart of a method for providing an adaptive map according to another embodiment of the present disclosure. Hereinafter, for convenience of explanation, the controller 120 of the moving object 100 and the processor 206 of the server 200, which process the process in FIG. 4, will be abbreviated to the moving object 100 and the server 200 respectively, but these terms may be used interchangeably.

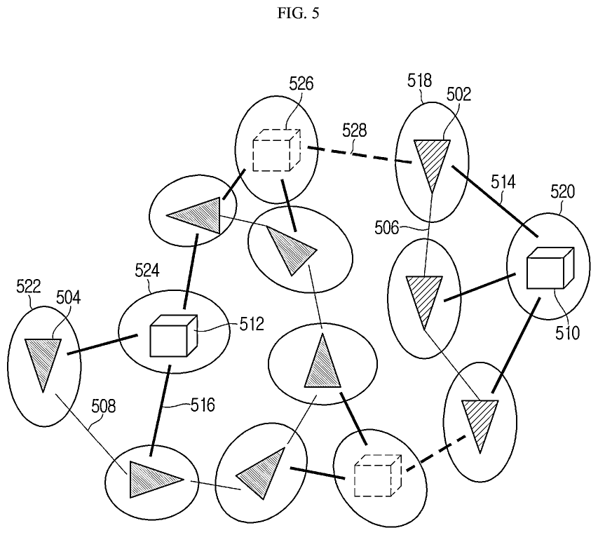

Referring to FIG. 4, the plurality of moving objects 100 exemplified in FIG. 1 may each obtain perception information and positioning information of an object element near the moving objects by using the observation sensors 104a to 104c and the positioning sensor 104d and generate object movement information associated with dynamic road objects including the moving objects 100 and a neighboring moving object (S105). Because the plurality of moving objects 100 perform an actually same process as that of FIG. 5, for convenience of explanation, the plurality of moving objects will be referred to as the moving object 100 below.

Perception information may include direct recognition information and indirect recognition information that the moving object 100 obtains. Direct recognition information is recognition information that the moving object 100 detects on its own, and indirect recognition information is recognition information that detects an object element exceeding a recognition range of a sensor of the moving object 100, and may be obtained from another moving object near the moving object 100.

Sensor data may be preprocessed to use the sensor data, which the moving object 100 obtains from the observation sensors 104a to 104c, as recognition information. Preprocessing may be accompanied by calibration, sensor fusion, feature extraction, and the like. Calibration may formulate a geometric model and radial models of a sensor and estimate and correct internal parameters. In addition, a geometrical relation defined among multiple sensors of the moving object 100 may be used in a process of sensor fusion. In the sensor fusion, a spatial frame of sensor data may be transformed so that the sensor data may be treated in a same reference frame based on a geometrical relation among multiple sensors. As for feature extraction, the moving object 100 may extract main features for environmental analysis from sensor data.

As for indirect recognition information, as exemplified in FIG. 1, the moving object 100 may be communicatively coupled with the neighboring moving object 400. The neighboring moving object 400 may be a mobility device of a different type, apart from a mobility device of the same type as the moving object 100, for example, a drone, a robot, and the like. As exemplified in FIG. 5, the moving object 502 may obtain recognition information detecting an object element exceeding a recognition range of its own sensor from another moving object 504. For example, the object element exceeding the recognition range of the sensor may be an object recognized due to a limit of sensing ability of the moving object 100, an object in a region occluded by an obstacle within an available sensing range, or an object in a blind spot.

FIG. 5 is a view exemplifying positioning and observational connectivity of a plurality of moving objects. The moving object 502 and the another moving object 504 are moved on a first driving path 506 and on a second driving path 508, respectively. The moving object 502 may directly recognize a first target object 510 near the first driving path 506 by using its own observation sensor. Connection between the moving object 502 and the first target object 510 directly recognized may be defined as a first observation relation 514. The another moving object 504 may directly recognize second target objects 512 and 526 near the second driving path 508, and connection between the another moving object 504 and the second target objects 512 and 526 directly recognized may be defined as a second observation relation 516. Recognition information of the first and second target objects 510, 512 and 526 detected by an observation sensor of each of the moving objects 502 and 504 may have expected perception errors 518, 520, 522 and 524 due to various causes. For example, the expected perception errors 518, 520, 522 and 524 may be caused by the observation sensors of the moving objects 502 and 504 and observational perception of the objects 510, 512 and 526. Accordingly, by considering the expected perception errors 518, 520, 522 and 524, each of the moving objects 502 and 504 may generate an optimal location that minimizes a spaced amount in relative displacement information, and thus estimate a location of each of the target objects 510, 512 and 526.

As shown in FIG. 5, the moving object 502 may not recognize the second target object 526 near the first driving path 506 by an observation sensor. Accordingly, the moving object 502 may receive recognition information that another moving object 504 obtains on its own, in constant communication with the another moving object 504. By analyzing recognition information, which the moving object 502 obtains on its own, and recognition information of another moving object 504, the moving object 502 may incorporate recognition information of the second target object 526 not recognized by the moving object 502 into perception information of the moving object 502. Recognition information of the second target object 526 is direct recognition information of the moving object 502, and thus the moving object 502 regards the target object as the re-observed target object 526, and the connection between the moving object 502 and the re-observed target object 526 may be defined as a re-observation relation.

Since sensor data collected by each moving object directly or indirectly are different with respect to sensor configuration, data format, and perceived target, the moving object 100 may process processes consisting of data transformation, similarity analysis, and optimal value decision in order to analyze sensor data.

In addition, perception information may be collected as multiple pieces of perception information such that the perception information may have multiple views in time series. Features are extracted according to each of multiple pieces of perception information, and relative displacement information between the observation sensors 104a to 104c and the features may be generated by matching between the features. For example, a feature may be a line of a target object, an edge, a predetermined shape of plane, or a geometric shape similar to a predesignated form. Extraction of features and matching between the features may be performed by referring to movement information and observation state information of the moving object 100. The observation state information may represent a state in which the observation sensors 104a to 104c of the moving object 100 perceive a target object. Observation state information may include an orientation, a position and the like of each sensor constituting the observation sensors 104a to 104c that observe an object according to a movement trajectory of the moving object 100 that is running. The moving object 100 may identify a same target object in multi-view perception information by applying a tracking algorithm employing an association method and/or a filtering technique (e.g. Kalman filter) and track a trajectory of the identified target object, that is, the running target object. In addition, multi-view tracking may reduce a temporary sensor noise or detection error and be used for accurate tracking of an object.

Meanwhile, the moving object 100 may generate positioning information of the moving object 100 by using perception information, a location detected from the positioning sensor 104d, a position, and pre-stored map information. Perception information may include direct recognition information and indirect recognition information. Apart from the above-described information, the positioning information may further include positioning information received from a neighboring moving object so that locations of multiple mobilities including the moving object 100 and the neighboring moving object may be estimated. Thus, information deficiency of the moving object 100 may be overcome, and positioning accuracy may be improved.

Location estimation by multiple mobilities may be realized using data fusion, collaboration of multiple devices (collaborative localization), an integrated approach, a stable network connection, and an adaptive algorithm.

Various sensors and mobilities may have their own feature. For example, satellite positioning is accurate outdoors but may not operate indoors, and on the other hand, positioning by Wi-Fi or Bluetooth shows good performance indoors but has a limitations outdoors. In addition, in a single moving object, recognition of an object element may have a limitation and an error according to a blind spot of data collection and performance of each sensor. Positioning through sensor data needs reference information for obtaining information on a location on a map. Disadvantages of a single device may be improved by combining sensor data and diverse data through data fusion.

When a plurality of mobilities share location information, positioning accuracy of an overall network according to the plurality of mobilities may be improved. For example, when a specific moving object has location information, other moving objects may share the location information of the specific moving object, and thus a positioning error may be reduced.

For accurate positioning, apart from data integration of a plurality of moving objects, the moving object 100 may use map information received from the server 200 and existing positioning information as supplementary information. In addition, as positioning information of each moving object is updated and shared in real time, uncertain positioning errors of each moving object may be corrected. The moving object 100 may obtain an optimal result by dynamically adjusting a positioning algorithm according to a situation of an object element and an environmental condition on a path.

By using perception information and positioning information, the moving object 100 may continuously detect moving objects including the moving object 100 and a dynamic road object and generate object movement information. Perception through detection of a moving object may be processed to identify a shape and an attribute of the object. The moving object 100 may obtain a movement path of a moving object by tracking a moving object by means of positioning information of the object estimated from the positioning sensor 104d and a trajectory based on an optimal location of the moving object. A trajectory of the moving object based on an optimal location is a trajectory where the moving object moves while being continuously observed, and a movement trajectory of the moving object may be estimated by using an optimal location according to perception information of the observation sensors 104a to 104c that the moving object 100 continuously obtains while running.

Next, the moving object 100 may transmit real-time environment information and diverse information to the server 200, and the server 200 may generate integrated environment information and path information based on the information and analyze these pieces of information (S110).

Based on perception information, positioning information, situation information around the moving object, operating information, and regulation information, the moving object 100 may generate real-time environment information and transmit the real-time environment information to the server 200. Situation information, operating information and regulation information may be received from an external device. Regulation information is information associated with a mandatory requirement applied to driving, for example, a speed limit, an altitude limit, a no-driving zone, a cautious driving zone, and the like.

The moving object 100 may transmit diverse information, which the server 200 uses to select optimal map information, to the server 200. Diverse information may include characteristics information of the moving object 100, user information, and mobility details information.

For example, characteristics information may include at least one of a type of the moving object 100, sensing performance of the moving object 100, processing performance of the moving object 100, and communication performance of the moving object 100. A type of a moving object may include at least one of a ground moving object, an aerial moving object, and a marine moving object. For example, sensing performance may be a resolution of the observation sensors 104a to 104c, a creation period, a synchronization method, and positioning accuracy of the positioning sensor 104d. For example, processing performance may be a processing specification of a resource like the controller 120 and the storage unit 118, a current available processing rate of a resource, and the like. For example, communication performance may be a transmission rate of the moving object 100, a communication protocol applied between the moving object 100 and the server 200, an attribute of a network connected to the moving object 100, a communication latency state of the moving object 100, and the like.

User information may include at least one of a preferred path on a course where the moving object 100 moves, and a path pattern. Mobility details information may include sensor information including a detailed specification of a sensor and detailed performance of a sensor and mobility constraint information according to the type and specification of the moving object 100.

The server 200 may generate integrated environment information based on information transmitted from the moving object 100 and path information of a moving object including at least the moving object 100. Environment information and path information may be constructed based on information transmitted from a plurality of moving objects 100. The server 200 may train and optimize an AI model based on information collected from the plurality of moving objects 100 and thus generate integrated environment information. As the environment information is forwarded to map information stored in the server 200 and the moving object 100, the accuracy of recognition may be improved.

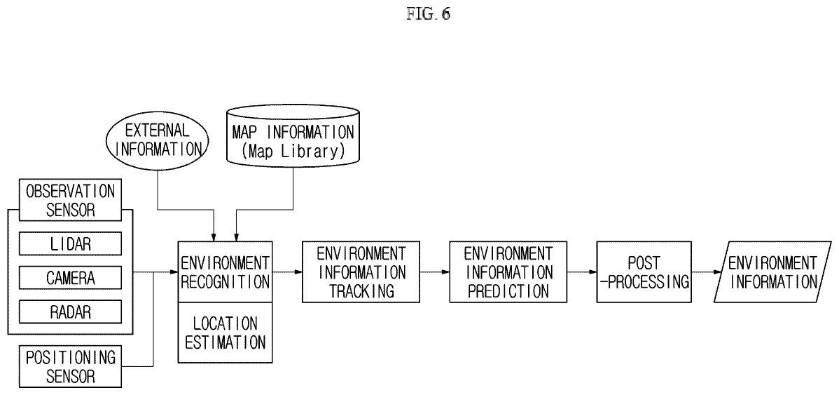

FIG. 6 is a view exemplifying generation processing of environment information.

The moving object 100 may obtain recognition information collected from an observation sensor and positioning information of a positioning sensor and receive map information and external information used by the moving object 100. By fusing the above information, the moving object 100 may recognize a real-time environment around the moving object and estimate a location. While keeping on tracking environment information according to a change of the above information, the moving object 100 may track an object movement path of the moving object. The moving object 100 transmits real-time environment information and an object movement path to the server 200, and the server 200 may generate predicted environment information and a predicted path expected in a course where the moving object is running, based on information and movement paths received from the plurality of moving objects 100.

Because predicted environment information and a predicted path are generated based on the plurality of moving objects 100 and thus may have uncertainty, the server 200 may generate a single piece of predicted environment information and a single predicted path by post-processing multiple pieces of predicted environment information from a geographically identical region and a plurality of predicted paths from a same moving object. For example, the server 200 may perform geometric matching between multiple pieces of predicted environment information and group similar predicted environment information based on statistical information according to a weight of predicted environment information. The server 200 may generate a single piece of predicted environment information by an environment estimation model based on the grouped predicted environment information. Thus, the server 200 may generate integrated environment information consisting of real-time environment information and predicted environment information. Post-processing of a predicted path is performed similar to predicted environment information, and a predicted path and an object movement path may be constructed as path information.

As path information includes a change trend of a moving object in a course, the time and history of each moving object at each movement point may be managed. For the accuracy of map information and navigation, time synchronization between data may accompany.

In addition, predicted environment information may include potential environment change information predicted based on past data accumulated in association with the above information.

As shown above, the server 200 is described to construct environment information in a centralized manner based on information received from the plurality of moving objects 100. As another example, when a connection relation is established between the plurality of moving objects 100, in communication between the plurality of moving objects 100 and the server 200, the plurality of moving objects 100 may mutually perform a local optimization process, and the server 200 may perform a global optimization process. Because the centralization is vulnerable to disorder of the server 200 and a large amount of traffic, the plurality of moving objects 100 may mutually generate local environment information and local path information, and the server 200 may construct extensive environment information and path information.

Next, the server 200 may select at least one piece of map information of multiple pieces of map information stored in the memory 204, based on characteristics information of the moving object 100 and environment information (S115).

Characteristics information and environment information referred to for selecting optimal map information have been described above and thus will be omitted below. Map information thus selected may include a state of an object element, a situation surrounding a moving object, an operation information of a traffic control facility, and regulation information. In addition, the selected map information may be constructed to include path information of the moving object 100 and a neighboring moving object. For the validity of path information, map information may be determined based on additional data managed by the server 200, apart from characteristics information and environment information. For example, additional data may include at least one of movement pattern information of the moving object 100, similarity information, use frequency of path information, modification frequency of path information, request frequency of a user for path information, and map evaluation information. Movement pattern information is identified by history information of the moving object 100, and the similarity information may be information on a path similar to a movement course or a traffic state of the course. Use frequency is frequency using path information in the course, and map evaluation information may be generated by simulation using a potential traffic state inferred from environment information.

The server 200 may manage multiple pieces of map information in a map library. The server 200 may manage and process map information tailored to diverse navigation platforms and scenarios. Map information may include static information, dynamic information, and semi-dynamic information. Multiple pieces of map information may have different levels of detailed information, resolutions and structures according to features and operating environments of moving objects. Map information may be classified and managed based on localization, recognition technology, operation geography, device type, type information (static information, dynamic information, semi-dynamic information), and time change information. Map information may store and provide information for path planning and determination of an autonomous moving object in various formats. Individual components constituting map information may be managed in a form of layers. An individual component is detailed map data affecting configuration of a path of an autonomous moving object and may be, for example, static information, dynamic information and semi-dynamic information. For example, dynamic information may include real-time behaviors of a vehicle, a pedestrian, and various types of moving objects. For example, semi-dynamic information may include factors changing at a predictable interval or under a specific condition such as a traffic light, a pedestrian cross signal, and a variable message sign. Semi-dynamic information may include a traffic flow state, a weather condition, a regulation, and a temporary change on a road. Because dynamic information and semi-dynamic station are in time series, timestamp is recorded for a time where corresponding information is generated or obtained, and the recency and relevance of information is evaluation, and the timestamp may be used for updates.

For example, managed map information may be a base map, a geometric map, an occupancy map, a semantic map, a prior knowledge map, a real-time knowledge, a map for positioning, and the like.

A base map may be a map made in a format according to a predetermined regulation. A base map may provide a basic structure and information for space information and ensure compatibility by overlapping a HD map on a map according to a format of the regulation, for example, a satellite map, an air map or a numerical map. In order to ensure compatibility, information capable of defining a reference coordinate system, such as a coordinate system scale, a center point, an axis, and an ellipsoid, may be included, and other layers may be arranged by the information of the reference coordinate system.

A geometric map may be a map that geometrically represents an object element of a road where the moving object 100 is capable of driving. A geometric map may represent movement environment information, for example, path information, in a two-dimensional or three-dimensional geometric forms like a polygon, a line, and a column.

An occupancy map may represent an object element having a dynamic behavior on a road in a two-dimensional or three-dimensional grid form. An occupancy map may include an occupancy state of a specific object in each grid and further introduce diverse information such as object attribute information and movement path information. In addition, as a grid is composed of multiple layers, multiple pieces of information may be recorded in a specific coordinate, and resolution according to system performance may be adjusted through a configuration of multiple resolutions.

A semantic map may include at least connection relation information that defines object elements connected on a road. A semantic map may record information on a lane, a traffic sign and a traffic light location, sign attribute information, and school zone information, which are used for operating navigation. A connection relation may be defined between each piece of the above information. For example, a traffic sign affecting a lane may be connected, and a speed limit value may be set corresponding to the lane.

A prior knowledge map may include at least operating information of an object element that controls driving of the moving object 100 on a road. For example, a prior knowledge map may support real-time decision making by providing information on standby time of a traffic light. Herein, by using data of crowdsourcing collected from a plurality of moving objects and an external device, a change trend may be predicted by learning through existing accumulated data. As a connection relation between the above data is defined, for example, when stop line information and traffic light information are connected, a mutual influential relation may be defined.

A real-time knowledge map may include at least connection relation information that defines mutually connected data among data belonging to situation information. For example, a real-time knowledge map may maintain its latest state by reflecting an immediate change of a driving environment such as a traffic change and a road construction work. In addition, by connecting information on a lane and a road construction work belonging to situation information, access limit information on the lane may be added to a real-time knowledge map.

A map for positioning may support positioning of the moving object 100. For example, a map for positioning may include a landmark map, an octree, and a cost map. A landmark map separately manage a feature of information useful for matching between sensor data, and when data of a corresponding region is recollected, the feature may be used for the purpose of matching. An octree divides a space into octants and thus may reduce search cost for accessing data of the space. Apart from an octree, a data structure like KD-tree may be used. A cost map may support decision making by allocating navigation cost to diverse regions. As high cost is allocated to a dangerous region and a traffic congested region, driving in such a region may be avoided.

A process of selecting map information may include evaluating combination of optimal SW and data through a combination of an algorithm, characteristics information, environment information, and past information thereof and providing latest map information to a navigation device.

When receiving environment information, the server 200 may identify and verify consistency of data belonging to the environment information. The server 200 may extract latest data by analyzing a time value of the data.

The server 200 may identify a type of the moving object 100 through characteristics information and determine requirement-specialized information according to the type of the moving object 100. Requirement-specialized information may include information required for the map information based on at least one of a moving object flow pattern, path safety degree, and function maintenance degree of a specific module of the moving object. For example, requirement-specialized information may analyze a type of a moving object, ability of the moving object, and constraint required for the moving object. As shown in this example, when a type is an autonomous vehicle, requirement-specialized information may include reflecting a road and a traffic pattern in map information and expressing an event on a road in the map information. When a type is a drone, requirement-specialized information may include, for example, securing path safety (clearance) for vertical movement and requesting map information that provides an altitude of a neighboring object and obstacle avoidance information.

In addition, as described above, the server 200 may select map information based on characteristics information, which includes at least one of sensing performance of a moving object, processing performance of the moving object, and communication performance of the moving object, environment information, and additional data.

The server 200 may analyze a network state of the moving object 100, computing performance, and functional constraint. Specifically, the server 200 may determine map information according to a type of a sensor, ability of the sensor, resolution of the sensor, positioning accuracy, periodicity, communication scheme, current transmission traffic state, and energy efficiency. For example, in case the resolution of a sensor is low, there is a lot of transmission traffic, or processing performance is low, in order to reduce the capacity of map information, map information thus selected may cover a smaller region than map information covering a wide region near a moving object. As another example, instead of map information with high accuracy and a large amount of detailed data, map information may be selected which consists of data with predetermined priority among data belonging to environment information or has low accuracy. Map information may be determined to connect traffic flow information, nearby event information, and a change of weather.

The server 200 may analyze a context of driving of the moving object 100 and an environment by using additional data. For example, when optimal map information is selected by analyzing a method of applying past data including a driving pattern, a signal path, a traffic flow, and user experience, that is, additional data to an existing navigation algorithm, supplementary according to the method may be referred to. In addition, map information may also be selected by analyzing the influence of operating environment according to additional data on driving performance.

The server 200 continuously optimizes the performance of an algorithm and variables used for the algorithm by analyzing map the use experience and result of each moving object. Through map use experience and driving experience, a weight applied to an algorithm and data may be enforced.

As movement data according to diverse navigation platforms is analyzed, a map selection strategy may be derived. For example, additional data herein analyzed may be a use frequency of navigation, a modification frequency, a travel distance, a user behavior, and the like.

In addition, the server 200 may predict a potential environment recognition and a driving result through various simulations. Thus, the server 200 may evaluate the performance of a map to be used in the moving object 100 in advance, and map information may be selected according to an evaluation result.

The server 200 may select multiple pieces of map information. For example, the server 200 may select different types of map information in a same region where the moving object 100 moves, or select different types of map information in different regions according to a movement path. The different regions may be regions with different time periods.

The server 200 may finally determine map information by evaluating multiple pieces of map information belonging to a map library based on characteristics information, environment information, and additional data. For example, an algorithm for each map for the library may calculate a fitness score based on a parameter according to the above-described information. The score may indicate agreement between a map and a current device, a user and an environmental context. As an example, map information with a highest score is selected, but as another example, by heuristics selection, map information may be determined by considering a user's preference, past feedback, or specific environmental nuance.

Next, the server 200 may adjust the map information in real time based on situation information indicating a situation around the moving object recognized from environment information (S210).

In the real-time adjustment of map information, if situation information is variable along a path of the moving object 100, map information in a zone with an event associated with the situation information may be processed based on the selected map information. For example, an individual component associated with an event zone may be provided as a layer in the selected map information. In addition, the real-time adjustment of map information may also mean that only map information in a zone with an event is provided as a map of a different type from the selected map information.

The server 200 may analyze a dynamic context through latest situation information to determine whether the real-time adjustment of map information is needed. For example, in case situation information is traffic congestion over a short time, a sudden accident, and a dramatic weather change, the server 200 may determine adjustment of map information based on the situation information and add an individual component matching the situation information to the selected map information.

In addition, based on at least one of path information, which has already been generated by past data associated with situation information, and path information derived from a prediction model according to learning based on the situation information, the server 200 may modify path information of the selected map information and adjust map information by the modified path information. For example, in case a path of a heavy rain and a continuous increase of traffic congestion are expected from current situation information, path information according to past data and/or a prediction model may be reflected in map information.

The above-described adjustment of map information is tuning according to predictive adaptation and may be implemented in various ways according to a type of a moving object. In the case of a robot, environment information associated with an event or construction work in a pedestrian zone in an urban environment may be considered, and map information may be adjusted to have path information with a low degree of congestion. In the case of a drone, environment information with an expected storm in a specific region may be considered, and map information may be adjusted to have path information that avoids the storm or a turbulence area or flies at a higher altitude. In the case of a marine moving object, environment information with expected proliferation of red tide or toxic tide may be considered, and map information may be adjusted to have path information that avoids a hazardous zone capable of damaging a sensor of a moving object.

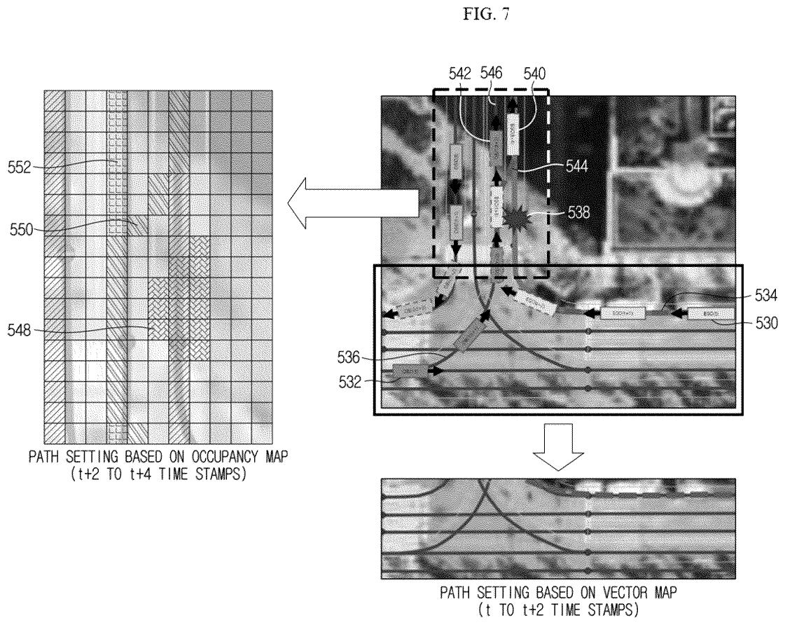

FIG. 7 exemplifies an example of adjusting map information by providing map information of a different type from selected map information. FIG. 7 is a view exemplifying real-time adjustment of map information.

Selected map information, that is, first map information is a vector map, and the first map information is a map constructed to enable a moving object 530 and a neighboring moving object 532 to autonomously run along a first movement path 534 and a second movement path 536 respectively. In case the server 200 receives situation information notifying an event 538 on a path, where the moving object 530 and the neighboring moving object 532 will move, for example, occurrence of a traffic accident, the server 200 may predict encountering the accident at a predicted location 540 of the moving object 530 and at a predicted location 542 of the neighboring moving object 532 according to the first and second movement paths 534 and 536. Accordingly, the server 200 may change the first movement path 534 and the second movement path 536 to a first predicted path 544 and a second predicted path 546, respectively, in a zone of the event 538. In addition, because the vector-based first map information simply shows the time-series locations and headings of an object element, the server 200 may determine based on the first map information that it is impossible to derive avoidance or safe driving in the zone of the event 538. The server 200 may generate second map information, for example, an occupancy map as map information of time stamps t+2 to t+4 corresponding to the zone of the event 538, while maintaining the first map information as map information of time stamps t to t+2 corresponding to a zone where the event 538 is not present. The second map information may be constructed to include an event occupancy region 548 corresponding to the zone of the event 538, a first path occupancy region 550 corresponding to the first predicted path 544, and a second path occupancy region 552 corresponding to the second predicted path 546. The server 200 may adjust map information in real time by employing the second map information that accurately provides a safe avoidance path, instead of the first map information in the zone where the event 538 occurs.

In addition, the sever 200 may also adjust map information in real time by another pieces of information of environment information and user information, apart from situation information. For example, according to a dynamic state of an object element, a user's preference, and the performance of a device mounted in the moving object 100, path information of map information may be changed, and thus the map information may be adjusted. Specifically, although map information is selected based on characteristics information, the map information may be transformed by detailed sensor information of mobility details information. For example, in a range of satisfying specific sensing performance according to a combination of the observation sensors 104a to 104c and the positioning sensor 104d, individual components in map information may be increased or decreased.

Next, the server 200 may adjust map information in detail based on user information and mobility details information (S125).

For example, the user information may include at least one of a preferred path on a course where the moving object moves, and a path pattern. The mobility details information may include sensor information including a detailed specification of the sensor unit 102 and detailed performance of the sensor unit 102 and mobility constraint information according to the type and specification of the moving object 100.

At least one of the server 200 and the moving object 100 may accumulate knowledges from paths experienced by a user and behaviors of the moving object 100, and the knowledges may be used for a determination of navigation. The server 200 may manage a unique behavioral map according to at least one of a preferred path and a path pattern and adjust details of map information based on the behavioral map. For example, in order to emphasize personalized waypoints in map information, detailed items displayed on the map information may be adjusted. Points of interest (POIs), for which a user's interest is estimated, for example, an charge station, a service area, or a specific landmark may be designated, and the POIs may be emphasized in map information. Map information recommends path information and a movement pattern to the moving object 100, but the map information may be adjusted to emphasize a user's preferred path information and his movement pattern over recommended information and patterns. In addition, while the moving object 100 is moved based on selected map information, the sever 200 may receive a user's feedback and adjust a part of path information according to the feedback.

As for adjustment based on mobility details information, the server 200 may minutely adjust map information based on the sensitivity of a sensor and a mobility constraint. For example, according to the detailed performance, resolution and observation range of a sensor, detailed data of map information may be adjusted. In case a moving object type is a ground robot or a drone, an object appearing as an available path in map information, for example a staircase may be processed as an available path, or a detailed altitude limit may be added to map information. According to a moving object type, map information may be processed such that a path and a road on the ground are shown in detail and an object corresponding to a flying altitude or a marine topography is simplified. On the other hand, map information may be processed such that the object corresponding to the flying altitude or the marine topography is shown in detail but the road on the ground is simplified.

Next, the server 200 may transmit the adjusted map information to the moving object 100 according to a predetermined method (S130).

Transmission according to the predetermined method may mean transmitting map information via a communication protocol determined based on, for example, a communication network environment, a bandwidth, communication performance of the moving object 100, traffic and the like. The transmission may be accompanied by authentication, error check, data integrity check, retransmission due to a transmission error, and a security protocol in the moving object 100 and the server 200. In addition, the transmission may include encoding and transmitting data exchanged between the server 200 and the moving object 100 including map information and feedback information and processing security update that changes a channel and a communication protocol with security vulnerability.

Next, the server 200 may obtain feedback information associated with use of map information obtained during the control of a movement of the moving object 100 according to the map information and update the map information based on the feedback information (S135).

For example, the feedback information may be the user's feedback or environment information affecting a movement to an actual movement path different from path information. The server 200 may update the map information based on result data which is verified by a simulation using movement data of the moving object 100 derived from the feedback information. Specifically, the simulation may virtualize a driving result of the moving object 100 and reproduce a reaction of the moving object 100 to environment information. The simulation may produce the user's interruption requiring a different behavior different information provided in the map information, evaluate the map information and an relevant algorithm, and update the map information according to an evaluation result.

The server 200 may combine feedback from the plurality of moving objects 100, apply the principles of DevOps, MLOps, and MapOps, and thus update the map information and the relevant algorithm more effectively. For example, by applying a labeling algorithm and a process for data of map information collected from feedback, map information may be generated, and the generated map information and existing map information may be updated through mutual analysis and checking. Thus, map information may be registered, and MapOps may be constructed. In addition, the collected data and the updated map information may be used as reference data and used for an AI model associated with map information, and such a model may attribute to automating a labeling task. Reference data lacking in learning performance enhancement may be improved through augmentation.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

What is claimed is:

1. A method for providing an adaptive map for diverse autonomous navigation platforms, the method comprising:
generating environment information around a moving object based on perception information acquired from the moving object equipped with a sensor;
selecting at least one piece of map information among multiple pieces of map information based on characteristics information of a type of the moving object, the moving object, which includes at least one of sensing performance of the moving object, processing performance of the moving object, and communication performance of the moving object, and the environment information;
adjusting the map information based on situation information representing a situation around the moving object recognized from the environment information; and
transmitting the adjusted map information to the moving object.

2. The method of claim 1, wherein the plurality of map information includes a base map made in a format according to a predetermined regulation, a geometric map geometrically expressing an object element on a road in which the moving object is drivable, an occupancy map that expresses an object element having a dynamic behavior on the road in a grid form, a semantic map including at least connection relation information that defines object elements connected on the road, a prior knowledge map including at least operating information of an object element that controls driving of the moving object on the road, a real-time knowledge map including at least association information that defines data mutually associated in the situation information, and a map for positioning for supporting positioning of the moving map.

3. The method of claim 1, wherein the perception information includes direct recognition information and indirect recognition information that the moving object acquires, the direct recognition information is recognition information that the moving object detects on its own, and the indirect recognition information is recognition information, which detects an object element beyond a perception range of a sensor of the moving object, and is recognition obtained from another moving object near the moving object.

4. The method of claim 1, wherein the environment information is generated based on perception information of an object element transmitted from the moving object and another moving object near the moving object, and the perception information is collected as multiple pieces of perception information in order to have multiple views in time series.

5. The method of claim 1, wherein the type of the moving object includes at least one of a ground moving object, an aerial moving object, and a marine moving object, the map information is selected based on at least requirement-specialized information determined according to the type of the moving object, and the requirement-specialized information includes information required for the map information based on at least one of a moving object flow pattern, path safety degree, and function maintenance degree of a specific module of the moving object.

6. The method of claim 1, wherein the map information is constructed to include path information of the moving object, and the map information is determined based on additional data together with the characteristics information of the moving object and the environment information of the moving object, and
wherein the additional data includes at least one of movement pattern information of the moving object, which is identified by history information of the moving object, similarity information on a path similar to a movement course or a traffic state of the movement course, a use frequency of the path information in the course, a modification frequency of the path information, a request frequency of a user for the path information, and map evaluation information generated by a simulation using a potential traffic state inferred from the environment information.

7. The method of claim 1, wherein the adjusting of the map information includes generating second map information corresponding to a presence region of the situation information by referring to first map information selected according to the environment information in front of the presence region and the environment information of the presence region, in response to the moving object being predicted to enter the presence region, and
wherein the first map information and the second map information are configured as different types of information.

8. The method of claim 1, wherein the adjusting of the map information includes providing path information to the map information based on at least one of path information already generated by past data associated with the situation information and path information derived from a prediction model according to training based on the situation information.

9. The method of claim 1, further comprising adjusting the map information in detail based on user information and mobility details information, prior to the transmitting of the adjusted map information to the moving object,
wherein the user information includes at least one of a preferred path in a course, where the moving object moves, and a path pattern, and the mobility details information includes sensor information including a detailed specification of the sensor and detailed performance of the sensor and mobility constraint information according to the type and a specification of the moving object.

10. The method of claim 1, further comprising:
acquiring feedback information associated with use of the map information obtained during control of a movement of the moving object according to the adjusted map information; and
updating the map information based on the feedback information,
wherein the updating includes updating the map information based on result data verified by a simulation using movement data of the moving object derived from the feedback information.

11. A device for providing an adaptive map for diverse autonomous navigation platforms, the device comprising:
a communication unit configured to exchange data with a moving object;
a memory configured to store at least one instruction; and
a processor configured to execute the at least one instruction by using the data,
wherein the processor is further configured to:
generate environment information around a moving object based on perception information acquired from the moving object equipped with a sensor,
select at least one piece of map information among multiple pieces of map information based on characteristics information of the moving object, which includes at least one of a type of the moving object, sensing performance of the moving object, processing performance of the moving object, and communication performance of the moving object, and the environment information,
adjust the map information based on situation information representing a situation around the moving object recognized from the environment information, and
transmit the adjusted map information to the moving object.
